(19) United States
(12) Patent Application Publication
(10) Pub. No.: US 2024/0421957 A1
(43) Pub. Date: Dec. 19, 2024

(54) CONTROL CHANNEL RECEPTION IN CELLULAR COMMUNICATION NETWORKS

(71) Applicant: Nokia Technologies Oy, Espoo (FI)

(72) Inventors: Timo KOSKELA, Oulu (FI); Jorma Johannes KAIKKONEN, Oulu (FI); Keeth Saliya Jayasinghe LADDU, Espoo (FI); Mihai ENESCU, Espoo (FI)

(21) Appl. No.: 18/702,561

(22) PCT Filed: Oct. 7, 2022
(86) PCT No.: PCT/EP2022/077883

§ 371 Date: Apr. 18, 2024

(30) Foreign Application Priority Data
Nov. 4, 2021 (FI) 20216137

(51) Int. Cl. H04L 5/00

(52) U.S. Cl. CPC H04L 5/0053; H04L 5/0094

(57) ABSTRACT

According to an example aspect of the present disclosure, there is provided an apparatus comprising means for receiving, from a wireless network node, an activation indication activating a Transmission Configuration Indicator. TCI, state for a control resource set, wherein the TCI state indicates a reference signal associated with a cell identifier, means for determining one or more control resource set parameters depending on the cell identifier and means for monitoring a downlink control channel using said one or more control resource set parameters.

### FIELD

Various example embodiments relate in general to cellular communication networks and more specifically, to control channel reception in such networks.

### BACKGROUND

Beam management may refer to a set of functionalities that can be used to enhance operation of beam-based wireless communication systems. Beam management may be used for example in various cellular communication networks, such as, in cellular communication networks operating according to 5G radio access technology. 5G radio access technology may also be referred to as New Radio, NR, access technology. 3rd Generation Partnership Project, 3GPP, develops standards for 5G/NR and one of the topics in the 3GPP discussions is related to beam management. According to the discussions there is a need to provide enhanced methods, apparatuses and computer programs related to beam management in cellular communication networks. Such enhancements may also be beneficial in other wireless communication networks as well.

### SUMMARY

According to some aspects, there is provided the subject-matter of the independent claims. Some example embodiments are defined in the dependent claims.

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect of the present disclosure, there is provided an apparatus comprising means for receiving, from a wireless network node, an activation indication activating a Transmission Configuration Indicator, TCI, state for a control resource set, wherein the TCI state indicates a reference signal associated with a cell identifier, means for determining one or more control resource set parameters depending on the cell identifier and means for monitoring a downlink control channel using said one or more control resource set parameters. The apparatus of the first aspect may be a user equipment or a control device configured to control the functioning thereof, possibly when installed therein.

Example embodiments of the first aspect may comprise at least one feature from the following bulleted list or any combination of the following features:
wherein at least one of said one or more control resource set parameters is specific for a first cell and at least one of said one or more control resource set parameters is specific for a second cell;
means for monitoring the downlink control channel using said one or more control resource set parameter of a first cell when the TCI state indicates a reference signal associated with a cell identifier of the first cell and means for monitoring the downlink control channel using said one or more control resource set parameter of a second cell when the TCI state indicates a reference signal associated with a cell identifier of the second cell;
wherein the first cell is a serving cell of the apparatus and the second cell is another cell than the serving cell of the apparatus;
wherein at least one of said one or more control resource set parameters to be used are conditionally activable depending on the cell identifier;
wherein said one or more parameters are search space specific;
wherein the search space is User Equipment specific Search Space, USS, or Common Search Space, CSS;
wherein the activation indication is a Medium Access Control MAC, Control Element, CE, activation indication or a Downlink Control Information, DCI, −based activation indication;
means for determining that said one or more control resource set parameters are not configured for the control resource set when the control resource set is activated with the TCI state indicating a reference signal associated with a cell identifier of another cell than a serving cell of the apparatus;
means for monitoring, upon determining that said one or more control resource set parameters are not configured for the control resource set, the downlink control channel using one or more control resource set parameters based on a cell identifier associated with a reference signal indicated by the active TCI state for the control resource set;
means for monitoring the downlink control channel using one or more control resource set parameters, wherein one or more parameters are based on a cell identifier associated with a reference signal indicated by the active TCI state for the control resource set;
means for performing said monitoring when the active TCI state indicates a reference signal associated with a cell different than a serving cell;
means for monitoring, upon determining that said one or more control resource set parameters are not configured for the control resource set, the downlink control channel using said one or more control resource set parameters of the cell identifier indicated by a reference signal associated with an active TCI state for the control resource set and for one or more search spaces configured for the control resource set;
means for monitoring the downlink control channel on the control resource set using said one or more control resource set parameters based on the cell identifier associated with a reference signal indicated by an active TCI state for the control resource set and for one or more search spaces configured for the control resource set;
wherein the cell identifier is a physical cell identifier or a re-indexed value of the physical cell identifier, and/or said one or more control resource set parameters comprise a Demodulation Reference Signal, DMRS, scrambling identity and/or precoder granularity;
means for receiving, from the wireless network node, a first control resource set configuration to be used when the TCI state indicates a reference signal associated with a cell identifier of a first cell and a second control resource set configuration to be used when the TCI state indicates a reference signal associated with a cell identifier of a second cell.

According to a second aspect, there is provided a method comprising, receiving, from a wireless network node, an activation indication activating a Transmission Configuration Indicator, TCI, state for a control resource set, wherein the TCI state indicates a reference signal associated with a cell identifier, determining one or more control resource set parameters depending on the cell identifier and means for monitoring a downlink control channel using said one or more control resource set parameters. The method may be performed by an apparatus, like a user equipment or a control device configured to control the functioning thereof, possibly when installed therein.

According to a third aspect of the present disclosure, there is provided an apparatus comprising at least one processing core, at least one memory including computer program code, the at least one memory and the computer program code being configured to, with the at least one processing core, cause the apparatus at least to receive, from a wireless network node, an activation indication activating a Transmission Configuration Indicator, TCI, state for a control resource set, wherein the TCI state indicates a reference signal associated with a cell identifier, determine one or more control resource set parameters depending on the cell identifier and monitor a downlink control channel using said one or more control resource set parameters. The apparatus of the third aspect may be a user equipment or a control device configured to control the functioning thereof, possibly when installed therein.

According to a fourth aspect of the present disclosure, there is provided a non-transitory computer readable medium having stored thereon a set of computer readable instructions that, when executed by at least one processor, cause an apparatus to at least to perform the method. According to a fifth aspect of the present disclosure, there is provided a computer program comprising instructions which, when the program is executed by an apparatus, cause the apparatus to carry out the method.

### BRIEF DESCRIPTION OF THE DRAWINGS

FIG. 1 illustrates an example of a network scenario in accordance with at least some example embodiments;

FIG. 2 illustrates a signaling graph in accordance with at least some example embodiments;

FIG. 3 illustrates an example apparatus capable of supporting at least some example embodiments;

FIG. 4 illustrates a flow graph of a method in accordance with at least some example embodiments.

### EXAMPLE EMBODIMENTS

Beam management in cellular communication networks may be enhanced by the procedures described herein. More specifically, control channel reception for inter-cell beam management scenarios in such networks may be enhanced by having one or more Control Resource Set, CORESET, parameters which may be conditionally activated using an activation indication. A wireless network node may transmit the activation indication to a User Equipment, UE, to activate a Transmission Configuration Indicator, TCI, state for a CORESET. The UE may, responsive to receiving the activation indication, determine said one or more conditional CORESET parameters to be used based on a cell identifier associated with a Reference Signal, RS, indicated by the TCI state. Therefore, issues related to throughput of individual UEs, network scheduling capacity and scheduling flexibility can be avoided, as different CORESET parameters may be used for different cells.

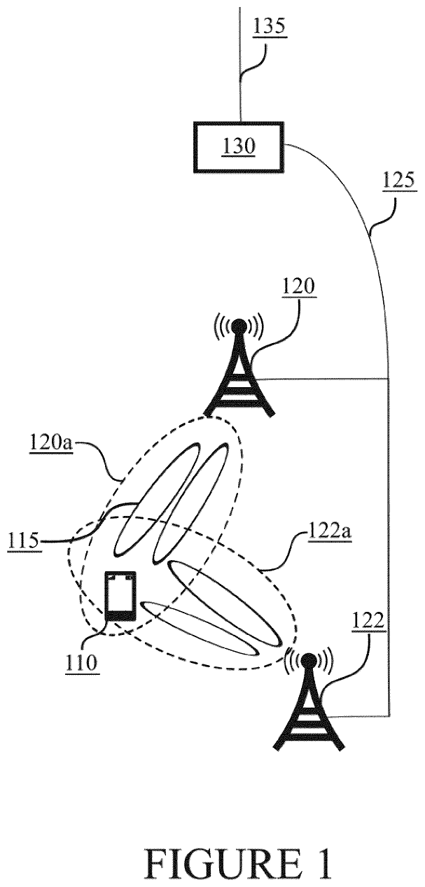

FIG. 1 illustrates an example of a network scenario in accordance with at least some example embodiments. According to the example scenario of FIG. 1, there may be a beam-based wireless communication system, which comprises UE 110, wireless network nodes 120, 122 and core network element 130. UE 110 may be connected to wireless network node 120 via air interface using at least one beam 115.

UE 110 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal or a relay. In the example system of FIG. 1, UE 110 may communicate wirelessly with wireless network node 120 via at least one beam 115. Wireless network node 120 may be considered as a serving node for UE 110 and one cell of wireless network node 120 may be serving cell 120a for UE 110. In some embodiments, wireless network node 120 may control another cell for communicating with UE 110 in addition to controlling serving cell 120a.

Wireless network node 122 may be another wireless network node communicating with UE 110. Wireless network node 122 may for example control another cell 122a, which is not serving cell 120a of UE 110, and UE 110 may receive at least dedicated channels from another cell 122a, wherein another cell 122a may have a different cell identifier than serving cell 120a.

Air interfaces between UE 110 and wireless network nodes 120, 122 may be configured in accordance with a Radio Access Technology, RAT, which both UE 110 and wireless network nodes 120, 122 are configured to support. Examples of cellular RATs include Long Term Evolution, LTE, New Radio, NR, which may also be known as fifth generation, 5G, radio access technology and MulteFire.

For example in the context of LTE, wireless network nodes 120, 122 may be referred to as eNBs while in the context of NR, wireless network nodes 120, 122 may be referred to as gNBs. In some example embodiments, wireless network nodes 120, 122 may be referred to as Transmission and Reception Points, TRPs, or control multiple TRPs that may be co-located or non-co-located. In any case, example embodiments of the present disclosure are not restricted to any particular wireless technology. Instead, example embodiments may be exploited in any beam-based wireless communication system, wherein inter-cell beam management would be beneficial.

Wireless network nodes 120, 122 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. Wireless network nodes 120, 122 may be connected, directly or via at least one intermediate node, with core network 130 or with another core network.

In some example embodiments, the network scenario may comprise a relay node instead of, or in addition to, UE 110 and/or wireless network nodes 120, 122. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of wireless network node 120, such as a gNB. Thus, in some example embodiments, the DU part of a relay may be referred to as wireless network node 120 and the DU may perform tasks of wireless network node 120;
2) Mobile Termination, MT, part which may facilitate functionalities of UE 110, i.e., a backhaul link which may be the communication link between a parent node (DU), such as a DU part of wireless network node 120, and the relay, such as an IAB node. In some example embodiments, the MT part may be referred to as UE 110 and perform tasks of UE 110.

Example embodiments of the present disclosure provide enhancements at least for inter-cell beam management scenarios, and in particular for control channel reception in such scenarios. For instance, embodiments of the present disclosure may be exploited in the context of further enhanced Multiple-Input Multiple-Output, feMIMO, for multi-beam operation by supporting inter-cell beam management. In case of inter-cell beam management, UE 110 may be configured to communicate with one or more additional cells, such as cell 122a shown in FIG. 1, having cell identifiers, like Physical Cell Identifiers, PCIs, which are different from the PCI of the serving cell, like serving cell 120a in FIG. 1. The serving cell may remain the same, i.e., the serving cell may not change while UE 110 communicates with one or more additional cells. The additional cell(s) may be referred as assisting cells, cells additional to serving cell, alternative cells, the cell configured for the inter-cell BM (or inter-cell mTRP) that is additional to the serving cell of the UE, may also be referred as a cell with a different PCI than the serving cell, different cell than serving cell, alternative cell, additional cell, inter-cell beam management cell, alternative PCI, additional PCI, a non-serving cell, or the like. In some embodiments, such an operation may be referred to as Dynamic Point Selection, DPS. The serving cell of UE 110 may not change but UE 110 may be configured and indicated to receive at least dedicated channels (at least one dedicated channel or channels) from the cell with a different PCI than serving cell while still maintaining the serving cell connection. In some examples, UE 110 may be configured to receive common channels (e.g. at least one common channel or channels) from the cell with a different PCI than the serving cell.

In case of inter-cell beam management, UE 110 may transmit to, or receive from, only a single cell at a time and the serving cell may not change when beam selection is done for another cell (e.g. the cell with a different PCI than the serving cell). In some embodiments, beam selection may comprise L1 measurement/reporting (e.g. L1-Reference Signal Received Power, RSRP, or providing L1-RSRP using L3 signaling) and/or beam indication associated with cell(s) with any PCI(s). The beam indication may be based for example on Rel-17 unified TCI framework. The same beam measurement/reporting mechanism may be reused for inter-cell multi-TRP scenarios. In some embodiments, only intra-DU and intra-frequency cases may be considered. Enhancements may be exploited to support multi-TRP deployment as well, targeting both Frequency Range, FR, 1 and FR2.

It may be necessary, or at least beneficial, to identify and specify features to improve reliability and robustness for channels other than Physical Downlink Shared Channel, PDSCH, (that is, Physical Downlink Control Channel, PDCCH, Physical Uplink Shared Channel PUSCH, and Physical Uplink Control Channel PUCCH) using multi-TRP and/or multi-panel deployments, with Rel. 16 reliability features as the baseline. In addition, it may be beneficial to identify and specify Quasi Co-Location, QCL, and TCI-related enhancements to enable inter-cell multi-TRP operations, assuming for example multi-DCI based multi-PDSCH reception based on Rel-15/16 TCI framework.

For example, for Rel-17 beam indication enhancements for inter-cell beam management, the supported Rel-17 Medium Access Control MAC, Control Element, CE,—based and/or Downlink Control Information, DCI,—based beam indication (at least using DCI formats 1_1/1_2 with and without downlink assignment including the associated MAC-CE-based TCI state activation) may apply to:
The channels and signals as for intra-cell beam management except for non-UE dedicated channels/signals. For inter-cell beam management, the support of more than one Rel-17 active DL TCI state/QCL per band is a UE capability;
   If a UE does not support such capability, MAC-CE based beam indication (activation of one TCI state) can be used to switch between two different DL receptions along two different beams.

Thus, non-dedicated channels cannot be indicated using the Rel-17 beam indication. In some embodiments, this may refer to separating indicated channels based on the UE-specific/dedicated Search Space, USS, and/or Common Search Space, CSS, configured for a CORESET. As an example, when a UE is indicated to monitor the PDCCH on a CORESET based on the indicated TCI state, the UE may assume that the indication applies for USS of the CORESET.

On the other hand, the non-UE dedicated channels, e.g., based search space type (USS/CSS) or the monitored Radio Network Temporary Identifier, RNTI, may need to be defined. As an example, a UE may be configured to monitor CSS for transmissions using C-RNTI (more specifically CSS-type3) and it may be determined to be a user specific channel instead of a non-UE dedicated channel.

In some examples, the dedicated channels may refer to at least PDCCH scheduled on a USS on a CORESET. In some examples, the dedicated channel may refer to at least a PDCCH scheduled on a CSS where UE the monitors a dedicated identifier, such as a C-RNTI. In some examples, the UE may monitor common channel(s) on the cell with a different PCI (than serving cell), the common channel(s) being scheduled according to a specific search space type. In one example, the search space type may be, e.g. CSS-type2 configuration, and used for monitoring paging on a CORESET.

A search space configuration may define one or more parameters for the UE, so that the UE knows how to search for PDCCH candidates in the CORESET in time and/or frequency domain. As an example, the search space configuration may have parameters such as periodicity of the search occasion, a number of monitored symbols within a slot, duration (i.e. consecutive slots that a search space lasts in every occasion, i.e., upon every period of the search space).

In case of Rel-17 beam indication, UE 110 may receive an activation indication for one or more TCI states (up to 8) which can be indicated by the network using DCI signaling. DCI signaling may indicate a TCI state code point which in turn may activate the TCI state for a CORESET. The activation indication may be for joint or separate beam indication.

In case of joint beam indication, like joint UL/DL beam indication, a UE may assume uplink and downlink channels (PDCCH/PUCCH/PDSCH (PUSCH) to be transmitted/received based on the RS indicated by the TCI state. In case of separate DL/UL beam indication, a TCI state may be indicated to the UE for either DL channel(s) reception or uplink channel transmission separately.

Some UEs may support only one active TCI state thus any MAC CE activation may activate a TCI state for the CORESET for at least downlink reception (e.g. PDCCH reception). This may be considered similar operation as Rel-15/Rel-16 beam indication where a MAC CE may activate one TCI state for a CORESET for PDCCH reception.

CORESET related definitions and parameters can be found from 3GPP standard specification TS 38.211. Smallest unit of resource in frequency domain in NR is called a Resource Element, RE, which refers to one Orthogonal Frequency Division Multiplexed, OFDM, subcarrier. 12 consecutive REs form a Resource Block, RB. A Resource Element Group, REG, consists of one resource block during one OFMD symbol. A Control Channel Element, CCE, consists of 6 resource-element groups. Furthermore, the CORESET defines a parameter reg-BundleSize for interleaved case which indicates the number of REGs that are considered to be in grouped or bundled.

Embodiments of the present disclosure may be associated with CORESET parameters, like pdcch-DMRS-ScramblingID and precoderGranularity:
pdcch-DMRS-ScramblingID: The Demodulation Reference Signal, DMRS, sequence for PDCCH transmitted on the specific CORESET is a pseudo random sequence and the parameter initializes the DMRS sequence generator with the configured value (0 . . . 65535). In case a parameter is not configured for a CORESET, the PCI value of the serving cell is assumed for initialization. Furthermore for the PDCCH on USS, the bit information transmitted on the PDCCH resources (prior to modulation) can be scrambled by a scrambling sequence where the sequence is partly initialized by the pdcch-DMRS-ScramblingID (together with C-RNTI), if configured.
precoderGranularity: tells the UE how the DMRS sequence is mapped to the resource elements (refer to TS38.211:7.4.1.3.2 Mapping to physical resources for specifics) and has two options:
precoderGranularity equals sameAsREG-bundle:
   the DMRS sequence is mapped within the resource element groups constituting the PDCCH the UE attempts to decode if the higher-layer parameter precoderGranularity equals sameAsREG-bundle
   all resource-element groups within the set of contiguous resource blocks in the CORESET where the UE attempts to decode the PDCCH if the higher-layer parameter precoderGranularity equals allContiguousRBs.

The above options may be referred sometimes as narrowband DMRS and wideband DMRS. In other words, the wideband DMRS sequence may run across all the REs of the CORESET whereas the narrowband DMRS sequence may be specific to the set of REGs that the UE tries to decode.

For inter-cell beam management and inter-cell mTRP, a UE may be configured with one or more CORESETs that may receive activation of a TCI State for PDCCH that indicates an RS associated with a PCI different than a PCI of a serving cell. Therefore, PDCCH reception for the search spaces (at least USS but possibly also one or more of CSS types) may be according to the TCI state and the CORESET resources carrying the PDCCH may be transmitted by another cell (and potentially configured for the UE to monitor for transmission), wherein said another cell may be associated with the PCI indicated by the TCI state which is different compared to the PCI of the serving cell).

This leads to following issues (but not limited to those) with respect to DMRS and PDCCH capacity that may impact the throughput of individual UEs and network scheduling capacity and scheduling flexibility:
Wideband DMRS & USS: In case of wideband DMRS configuration (allContiguousRBs) network is not able to schedule UEs of two different cells at the same time due to different DMRS sequences, thereby limiting the operation in both cells, the serving cell and the cell with a different PCI compared to the serving cell;
Narrowband DMRS & CSS: In case of narrowband DMRS and CSS, a cell may not be able to schedule common channels for UEs on same REGs due to the multiple PDCCH DMRS scrambling candidate values. That is, a cell may need to provide common channels for the UEs that assume the specific cell to be the serving cell and for the inter-cell users. The aggregation levels, such as number of CCEs used for PDCCH transmission for common channels, may be high and thus the number of PDCCH candidate locations may be limited, thereby limiting the network scheduling flexibility;
Narrowband/Wideband DMRS & no scramblingID configured: A CORESET may utilize the PCI of the serving cell for scrambling which may require network to schedule with more than one DMRS scrambling assumption for a specific CORESET. This may limit the network scheduling flexibility and reduce the network and UE specific throughput.

Embodiments of the present disclosure therefore improve control channel reception for inter-cell beam management scenarios. With reference to FIG. 1 again, UE 110 may determine to apply one or more CORESET specific parameters, wherein said one or more CORESET parameter may be conditionally activated/used upon receiving an activation indication of a TCI state for a CORESET. The TCI state may indicate a RS associated with a cell identifier, like a PCI, and UE 110 may determine said one or more CORESET parameter depending on the cell identifier. That is, at least one of said one or more CORESET parameters may be different for different cell identifiers.

In any of the embodiments herein, a TCI state may be associated with a specific cell. In one example, the TCI state may indicate a RS that is associated with a cell identifier (e.g. PCI, physical cell identifier, or a cell index value that maps to a specific PCI). Association may be configured by the network. Association may indicate to the UE which cell (e.g., which cell identifier) is expected to transmit the specific RS(s). Additionally or alternatively, an RS may be associated with a specific cell through the QCL source RS. If an RS (e.g. Channel State Information, CSI-RS) has a QCL source RS that is associated with a specific PCI (e.g., Synchronization Signal Block, SSB, SS-Physical Broadcast Channel, PBCH, Block) it may mean that the RS is associated with the specific PCI (that of the QCL source RS). (Configuration of) QCL assumption between an RS and a source RS may indicate to the UE that the RS can be assumed to have similar characteristic, i.e., spatial RX (can be received using same RX beam), or have the same delay spread/doppler shift.

Different CORESET parameters may be used for monitoring a downlink control channel differently depending on the cell identifier, i.e., depending on the cell. For instance, a CORESET parameter, e.g., a first DMRS scrambling identity, may be applied for a first cell and a corresponding CORESET parameter of a second cell, a second DMRS scrambling identity, may be applied for a second cell. In some embodiments, the first cell may be a serving cell, like serving cell 120a, and the second cell may another cell, like another cell 122a. Monitoring of downlink control channel on a CORESET (or in a search space or spaces) may comprise of determining the DMRS scrambling sequence (e.g. using DMRS-ScramblingID) and/or determining the scrambling for the information bits of the PDCCH. The downlink control channel monitoring may use parameters/sequences/sequence initializations/scrambling that may depend on the PCI association with the RS indicated by the active TCI state for the CORESET.

For instance, the TCI state may indicate a RS associated with a different PCI compared to a PCI of the serving cell, like serving cell 120a, for example if UE 110 is configured with a PCI association with different CORESET parameters, such as pdcch-DMRS-ScramblingID and/or precoderGranularity. The activation indication may be transmitted for example using a MAC CE or DCI. That is, the activation indication may be a MAC CE activation indication or a DCI-based indication for activating the TCI state. In some example embodiments, the CORESET configuration, comprising at least said one or more parameters, of the serving cell may be considered as default parameters, i.e., a first set of parameters.

In some embodiments, UE 110 may determine that at least one search space is monitored on the CORESET with the indicated TCI state, the indicated TCI being associated with a different PCI compared to the PCI of the serving cell, and UE 110 may then assume the PCI specific CORESET parameters for the CORESET when monitoring the PDCCH on the CORESET resource on a cell having a different PCI than the serving cell.

In some embodiments, the CORESET parameters may be further search space specific, i.e., UE 110 may monitor a specific search space on the CORESET resources based on the active TCI state indicating RS associated with a different PCI than the serving cell. As an example, individual search space configuration in the CORESET may have one or more set of parameters that are conditionally used/applied by UE 110, based on the SS/PDCCH monitoring assumption of UE 110. If UE 110 is assumed to monitor, e.g., USS on the CORESET when active TCI state indicates a different PCI than the serving cell, if configured, UE 110 may apply the PCI and/or cell specific parameters set for the CORESET when monitoring the PDCCH according to the USS configuration.

In some examples, when a CORESET has an active TCI state indicating a different PCI than a PCI of the serving cell, UE 110 may be configured to monitor USS and one or more type(s) of CSS on the CORESET according to the cell (i.e., PCI) specific parameters (if provided or configured). Thus, in some examples, UE 110 may be configured to monitor the PDCCH on a specific/subset of SS (e.g., USS only, USS and specific CSS, or all SS, or all CSS but not USS etc.) in a CORESET when the active TCI state indicates a different PCI than the serving cell for the CORESET. Each SS configured for the CORESET may further have one or more set of parameters that are specific to, and/or associated with, a PCI value associated with the CORESET monitoring. In another example, the CORESET parameters specific to a PCI are applied based on the active TCI state and the PCI indicated by the active TCI state. These parameters may be applied when monitoring the CORESET according to the SS configuration.

In some embodiments, individual parameter(s) of a CORESET, like precoderGranularity and/or pdcch-DMRS-ScramblingID, may be conditionally changed based on the TCI state activation for the CORESET. The conditional change may further depend on the PCI association of the RS indicated by the active TCI state.

In some embodiments, individual parameter(s) of a CORESET, like precoderGranularity and/or pdcch-DMRS-ScramblingID, may be conditionally changed based on the TCI state activation for the CORESET and may be specific to a search space that is used for monitoring the CORESET for the PDCCH. The conditional change may further depend on the PCI association of the RS indicated by the active TCI state.

In any of the embodiments herein, the indication activating a TCI State for a CORESET may refer to activation of a TCI State for at least one PDCCH. The indication may be a MAC CE indication or a DCI indication (i.e., DCI may point to a specific activated TCI state (referred with a codepoint)).

In some embodiments, if UE 110 receives an indication activating a TCI State for a CORESET and the TCI state indicates an RS associated with the PCI of the serving cell, UE 110 may determine to apply a first set of CORESET parameters, e.g., pdcch-DMRS-ScramblingID and/or precoderGranularity) for PDCCH reception on the CORESET resources. The first set of CORESET parameters may be referred to as default/configured parameters for the CORESET. That is, UE 110 may assume the first set of parameters as default/configured parameters for the CORESET. This first set may refer to a parameters used for serving cell PDCCH monitoring on a CORESET.

Alternatively or additionally if UE 110 receives an activation indication activating a TCI state for a CORESET and the TCI state indicates an RS associated with a different PCI than the serving cell, UE 110 may determine to apply a second set of CORESET parameters, e.g., pdcch-DMRS-ScramblingID and/or precoderGranularity) for PDCCH reception on the CORESET resources. The second set of CORESET parameters may comprise at least one parameter that is not in the first set of CORESET parameters. That is, UE 110 may assume, if provided with the association of the CORESET parameters with the PCI, the specific parameter(s) for the CORESET, instead of the default/configured ones, when monitoring PDCCH on that CORESET. The second set of parameters may be specific for all the SS in the CORESET that are monitored on the PCI other than the serving cell, or the second set of parameter(s) may only apply a specific SS.

In an example, the first set of CORESET parameters may be applied for SS #1 (search space #1) and UE 110 may monitor the PDCCH according to the SS configuration and apply the first set of parameters for the CORESET. In a further example, if SS #2 (search space #2) has a configuration of the second set of parameters (that is conditional to a PCI assumption of the transmission), UE 110 may apply the second set of parameters for the CORESET when monitoring the PDCCH according to the second set.

In some examples, one or more search spaces may be configured for the CORESET(s) that are considered to be active when a specific PCI is indicated by the TCI state. As an example, SS #1 (USS or CSS) may be active, i.e., UE 110 may assume the PDCCH monitoring according to an SS configuration, if the active TCI state for a CORESET indicates an RS associated with specific PCI #1 (e.g., the PCI of the serving cell). As a further example, SS #2 may be active if the active TCI state for a CORESET indicates a RS associated with specific PCI #2 (different than the PCI of the serving cell). Thus, the active SS for the CORESET may depend on the RS association with a specific PCI indicated by the active TCI state. In some examples, the SS #1 and SS #2 may not be concurrently active. In some examples, the SS #1 and SS #2 may be active for PCI1 (when the active TCI state for the CORESET indicates an RS of PCI1) but only SS #2 may be active for PCI2 (when the active TCI state for the CORESET indicates an RS of PCI2).

The CORESET parameters of the first set, e.g., the CORESET parameters of the serving cell parameters may be indicated in a CORESET Radio Resource Control, RRC, configuration explicitly and/or the CORESET parameters of the second set, i.e., the additional parameters, may be indicated explicitly.

In some embodiments, the CORESET parameters configured for the serving cell operation may be considered, e.g., pdcch-DMRS-ScramblingID and/or precoderGranularity, such that the sequence generation of the PDCCH DMRS for the CORESET uses the cell identifier, like a PCI, indicated by the currently active TCI state for the CORESET (e.g., the active TCI state may indicate an RS associated with a PCI).

In some embodiments, if the at least one CORESET parameter is not configured for the CORESET that is activated with the TCI State indicating the RS associated with a different PCI than a PCI of the serving cell, UE 110 may determine that the sequence generation of the PDCCH DMRS (e.g., the pdcch-DMRS-ScramblingID) for the CORESET uses the cell identifier indicated by the currently active TCI state for the CORESET. That is, UE 110 may determine in general that one or more CORESET parameters are not configured for the CORESET, wherein the CORESET is activated with the TCI state indicating a cell identifier of another cell 122a and monitor the PDCCH using said one or more CORESET parameters based on a cell identifier indicated by an RS associated with an active TCI state for the CORESET. For example, the PCI may be directly used for DMRS sequence generation.

In some embodiments, said monitoring may not depend on whether said one or more parameters are configured, i.e., said one or more parameters may be configured for UE 110 but based on a cell identifier when the indicated RS indicates a cell different from the serving cell. For instance, UE 110 may perform said monitoring when the active TCI State indicates an RS associated with a cell different than a serving cell.

As an example, at least one CORESET parameter (e.g., pdcch-DMRS-ScramblingID) may depend on the PCI associated with the RS indicated by the active TCI state for the CORESET. When the active TCI state indicates the PCI of the serving cell, at least one CORESET parameter (e.g. pdcch-DMRS-ScramblingID) may be determined to be based on the serving cell PCI (e.g, the parameter is the PCI value or the PCI value is used as a parameter, used at least partly as the parameter or used for deriving the parameter). When the active TCI state indicates an RS associated with a PCI (e.g. other than the serving cell), at least one CORESET parameter (e.g. pdcch-DMRS-ScramblingID) may be determined to be based on the PCI value (e.g., is the PCI value or the PCI value is used as a parameter, used at least partly as the parameter or used for deriving the parameter). When the active TCI state indicates an RS associated with a (specific) PCI, at least one CORESET parameter (e.g. pdcch-DMRS-ScramblingID) may be determined to be based on the PCI value (e.g., is the PCI value or the PCI value is used as a parameter, used at least partly as the parameter or used for deriving the parameter).

In some embodiments, if the at least one CORESET parameter is not configured for the CORESET that is activated with a TCI State indicating an RS associated with a different PCI than serving cell, UE 110 may determine that the sequence generation of the PDCCH DMRS for the CORESET uses the cell identifier indicated by the currently active TCI state for the CORESET and for one or more search spaces configured for the CORESET. In another example, UE 110 may determine that the sequence generation of the PDCCH DMRS for the CORESET uses the cell identifier indicated by the currently active TCI state for the CORESET. UE 110 may determine that the sequence generation of the PDCCH DMRS for the CORESET uses the cell identifier indicated by the currently active TCI state for the CORESET and for one or more search spaces configured for monitoring the PDCCH transmission on the CORESET. In another example, UE 110 may determine that the sequence generation of the PDCCH DMRS for the CORESET uses the cell identifier indicated by the currently active TCI state when the active TCI state indicates a RS associated with a PCI different than the PCI of the serving cell for the CORESET, and possibly for one or more search spaces configured for monitoring the PDCCH transmission on the CORESET. That is, UE 110 may further monitor the PDCCH using said one or more CORESET parameters of the PCI indicated by an RS associated with the currently active TCI state for the CORESET and for one or more search spaces configured for the CORESET.

In some embodiments, said monitoring may not depend on whether said one or more parameters are configured. UE 110 may monitor the PDCCH on the CORESET using said one or more CORESET parameters based on the cell identifier indicated by a RS associated with an active TCI state for the CORESET and for one or more search spaces configured for the CORESET.

If UE 110 monitors the PDCCH on at least one search space on at least one CORESET associated with an active TCI, the active TCI being further associated with a serving cell and the PCI of the serving cell, UE 110 may use the default parameters provided for the CORESET. In an example, these search spaces may be CSS search spaces or CSS with specific type, like the types that may be monitored on the serving cell in case of the inter-cell communication, such as CSS type0/1, but not limited to those.

If UE 110 monitors the PDCCH on at least one search space on at least one CORESET associated with an active TCI state, the active TCI state indicating a RS being further associated with a PCI different than the PCI of the serving cell, UE 110 may use the serving (or e.g. the default) parameters provided for the CORESET. In an example, these search spaces may be CSS search spaces (in some cases USS) or CSS with a specific type, like the types that may be monitored on the different cell than the serving cell (in case of the inter-cell communication), such as CSS type0/1 or CSS-typ2 or CSS-type3, but not limited to those.

In some examples, a CORESET may be configured with a search space which may be associated with first and second sets of CORESET parameters. Use of the first or second set may depend on the PCI association of the indicated RS of the active TCI state for the CORESET. For example PCI1 (e.g., the PCI of the serving cell) may cause UE 110 to apply the first set of parameter(s) and PCI2 (e.g., the PCI of the cell different than the PCI of the serving cell) may cause UE 110 to apply the second set of parameter(s). In case a second set is not provided, or not configured or are absent, UE 110 may apply the same parameters for CORESET monitoring for any indicated PCI (e.g., the serving cell or the cell different than the serving cell) by the RS indicated by the active TCI state for the CORESET.

If UE 110 monitors the PDCCH on at least one search space associated with an active TCI, the active TCI being further associated with another cell and a PCI different than a PCI of the serving cell, UE 110 may apply specific CORESET parameters provided for the search space monitoring on the CORESET that are associated with a specific PCI. In an example, if UE 110 monitors USS and/or CSS (e.g. type3 or type2), UE 110 may assume conditionally to use the specific CORESET parameters. That is, said one or more conditional CORESET parameters may be search space specific.

In some embodiments, the individual parameters in a CORESET, (e.g. precoderGranularity and/or pdcch-DMRS-ScramblingID) may be conditionally changed based on the TCI state activation for the CORESET and used for the specific search space, like USS/CSS.

In some embodiments. UE 110 may determine that the CORESET parameter (e.g. pdcch-DMRS-ScramblingID, precoderGranularity) may apply only for the PDCCH DMRS sequence generation, only for the information bit scrambling for the PDCCH or both PDCCH DMRS sequence generation and PDCCH information bit scrambling. The CORESET parameter(s) herein may be search space specific. For example, when monitoring a CORESET according to a specific search space, UE 110 may apply search space specific parameters (e.g., for PDCCH DMRS sequence generation, only for the information bit scrambling for the PDCCH or for both).

In some embodiments, a cell specific identifier associated with an RS (that may be indicated by a TCI state) may be a PCI or a re-indexed value of the PCI. In case of the re-indexed value of the PCI, for example the PCI=231 may be re-indexed with another value e.g. PCI_reindex=1, PCI=131->PCI_reindex=2 and so on. Re-indexing or indexing of PCI values may be configured by network (e.g. via RRC). Serving cell may be assigned a default value of PCI_reindex=0, or a separate value may be configured. Embodiments of the present disclosure may be applied for any cell identifier in general, even though the PCI is used as an example in various embodiments.

In some embodiments, the CORESET configuration may include one or more parameters that are conditionally used. The condition may be an activation of a TCI state for a CORESET that indicates an RS associated with a PCI different from a PCI of the serving cell. As an example of a CORESET configuration it may have a PCI specific value for at least one parameter in the configuration. Alternatively, a separate configuration may be used, e.g, an RRC configuration/information element, that provides association between at least one CORESET parameter and the PCI, and is conditionally used.

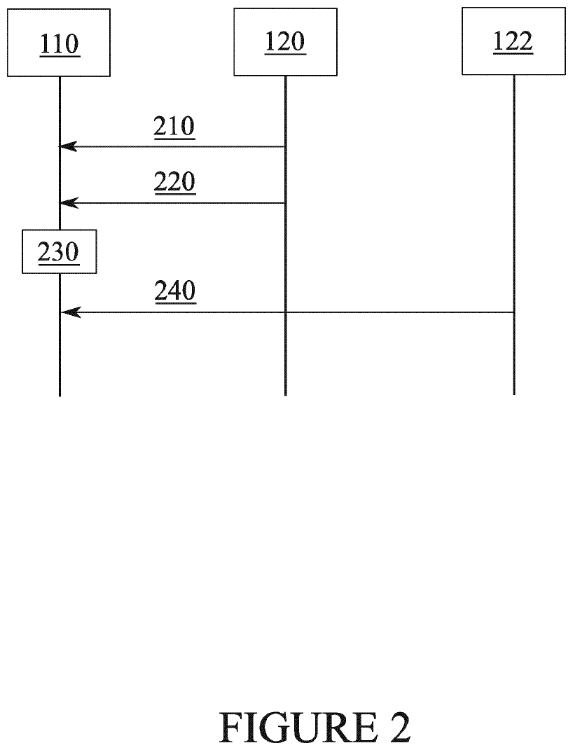

FIG. 2 illustrates a first signaling graph in accordance with at least some example embodiments. On the vertical axes are disposed, from the left to the right, UE 110, wireless network node 120 and another wireless network node 122. Time advances from the top towards the bottom.

At step 210, UE 110 may receive, from wireless network node 120, a first CORESET configuration to be used if an activated TCI state indicates an RS associated with a cell identifier of a first cell, like serving cell 120a, and a second CORESET configuration to be used when the TCI state indicates an RS associated with a cell identifier of a second cell, like another cell 122a. The first CORESET configuration may comprise at least one parameter which is different compared to a corresponding parameter in the second CORESET configuration.

At step 220, UE 110 may receive, from wireless network node 120, an activation indication activating a TCI state for a CORESET, wherein the TCI state indicates an RS associated with a cell identifier, like a PCI. At step 230, UE 110 may determine one or more CORESET parameters depending on the cell identifier. That is, UE 110 may determine that the parameters of the first CORESET configuration are to be used if the cell identifier indicates the first cell, like serving cell 120a. Alternatively, UE 110 may determine that the parameters of the second CORESET configuration are to be used if the cell identifier indicates the second cell, like another cell 120b.

In some embodiments, at least one of said one or more CORESET parameters is specific for the first cell and at least one of said one or more CORESET parameters is specific for the second cell. For instance, at least one of said one or more CORESET parameters of the first cell may be different compared to at least one of said one or more CORESET parameters of the second cell.

For instance, UE 110 may start monitoring the PDCCH using said one or more CORESET parameters of the first cell when the TCI state indicates an RS associated with a cell identifier of serving cell 120a. Alternatively, UE 110 may start monitoring the PDCCH using said one or more CORESET parameter of the second cell when the TCI state indicates an RS associated with a cell identifier of another cell 122a. Hence, said one or more control resource set parameters to be used may be conditionally changed depending on the cell identifier. That is, said one or more control resource set parameters to be used may be used/applied/activable/changeable/activated depending on the cell identifier.

FIG. 2 illustrates a scenario, wherein the TCI state indicates an RS associated with the cell identifier of another cell 122a. Hence, another wireless network node 122 may transmit, at step 240, control information using said one or more control resource set parameter of the second cell and UE 110 may receive said control information accordingly.

However, in some other embodiments, the TCI state may indicate an RS associated with the cell identifier of serving cell 120a. In such a case, wireless network node 120 may transmit control information using said one or more control resource set parameter of the first cell and UE 110 may receive said control information accordingly.

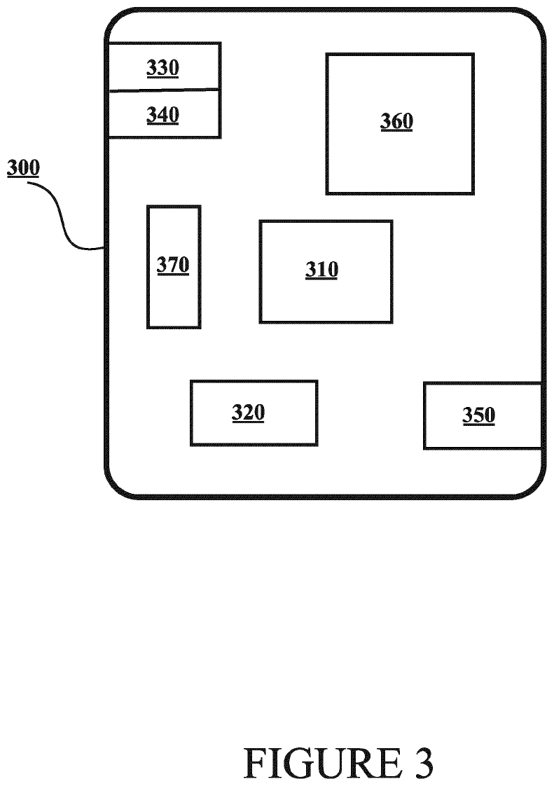

FIG. 3 illustrates an example apparatus capable of supporting at least some example embodiments. Illustrated is device 300, which may comprise, for example, UE 110, or a control device configured to control the functioning thereof, possibly when installed therein. Comprised in device 300 is processor 310, which may comprise, for example, a single— or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with Global System for Mobile communication, GSM, Wideband Code Division Multiple Access, WCDMA, Long Term Evolution, LTE, and/or 5G/NR standards, for example.

Device 300 may comprise a Near-Field Communication, NFC, transceiver 350. NFC transceiver 350 may support at least one NFC technology, such as Bluetooth, Wibree or similar technologies.

Device 300 may comprise User Interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a Subscriber Identity Module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

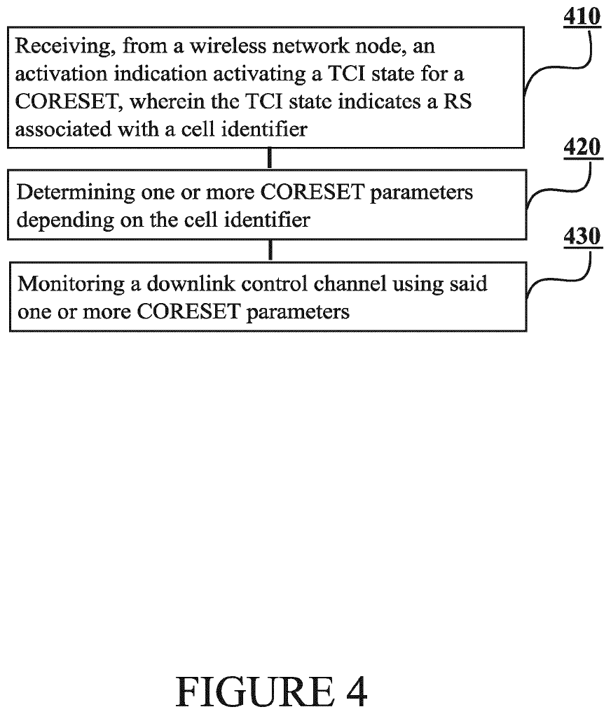

Device 300 may comprise further devices not illustrated in FIG. 4. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some example embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the example embodiment various ways of interconnecting at least two of the aforementioned devices may be selected without departing from the scope of the example embodiments.

FIG. 4 is a flow graph of a first method in accordance with at least some example embodiments. The phases of the illustrated first method may be performed by apparatus 300, like UE 110 or by a control device configured to control the functioning thereof, possibly when installed therein.

The method may comprise, at step 410, receiving, from a wireless network node, an activation indication activating a Transmission Configuration Indicator, TCI, state for a control resource set, wherein the TCI state indicates a reference signal associated with a cell identifier. The method may also comprise, at step 420, determining one or more control resource set parameters depending on the cell identifier. Finally, the method may comprise, at step 430, monitoring a downlink control channel using said one or more control resource set parameters.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, such as, UE 110, may comprise means for carrying out the example embodiments described above and any combination thereof.

In an example embodiment, a computer program may be configured to cause a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, such as, UE 110, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the disclosure. One skilled in the relevant art will recognize, however, that the disclosure can be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks, for example in 3GPP networks, wherein beamforming is used.

ACRONYMS LIST

| | |
|---|---|
| 3GPP | 3rd Generation Partnership Project |
| BS | Base Station |
| CE | Control Element |
| CORESET | Control Resource Set |
| CSI | Channel State Information |
| DCI | Downlink Control Information |
| DMRS | Demodulation Reference Signal |
| DPS | Dynamic Point Selection |
| DU | Distributed Unit |
| feMIMO | further enhanced Multiple-Input Multiple-Output |
| FR | Frequency Range |
| GSM | Global System for Mobile communication |
| IAB | Integrated Access and Backhaul |
| IoT | Internet of Things |
| LTE | Long-Term Evolution |
| M2M | Machine-to-Machine |
| MAC | Medium Access Control |
| MT | Mobile Terminal |
| NFC | Near-Field Communication |
| NR | New Radio |
| OFDM | Orthogonal Frequency Division Multiplexed |
| PBCH | Physical Broadcast Channel |
| PCI | Physical Cell Identifier |
| PDCCH | Physical Downlink Control Channel |
| PDSCH | Physical Downlink Shared Channel |
| PUCCH | Physical UL Control Channel |
| PUSCH | Physical UL Shared Channel |
| QCL | Quasi Co-Location |
| RAN | Radio Access Network |
| RAT | Radio Access Technology |
| RB | Resource Block |
| RE | Resource Element |
| REG | Resource Element Group |
| RNTI | Radio Network Temporary Identifier |
| RRC | Radio Resource Control |
| RS | Reference Signal |
| RSRP | Reference Signal Received Power |
| SSB | Synchronization Signal Block |
| TCI | Transmission Configuration Indicator |
| TRP | Transmission and Reception Point |
| UE | User Equipment |
| UI | User Interface |
| UL | UL |
| WCDMA | Wideband Code Division Multiple Access |
| WiMAX | Worldwide Interoperability for Microwave Access |
| WLAN | Wireless Local Area Network |

REFERENCE SIGNS LIST

| | |
|---|---|
| 110 | UE |
| 115 | Beams |
| 120 | Wireless network node |
| 120a | Serving cell |
| 122 | Another wireless network node |
| 122a | Another cell |
| 125, 135 | Wired interfaces |
| 130 | Core Network |
| 210-240 | Steps in the signaling graph of FIG. 2 |
| 300-370 | Structure of the apparatus of FIG. 3 |
| 410-430 | Phases of the method in FIG. 4 |

1-17. (canceled)

18. An apparatus comprising at least one processing core, at least one memory including computer program code, the at least one memory and the computer program code being configured to, with the at least one processing core, cause the apparatus at least to:
receive, from a wireless network node, an activation indication activating a Transmission Configuration Indicator (TCI) state for a control resource set, wherein the TCI state indicates a reference signal associated with a cell identifier;
determine one or more control resource set parameters depending on the cell identifier; and
monitor a downlink control channel using said one or more control resource set parameters.

19. The apparatus according to claim 18, wherein at least one of said one or more control resource set parameters is specific for a first cell and at least one of said one or more control resource set parameters is specific for a second cell.

20. The apparatus according to claim 19, wherein the first cell is a serving cell of the apparatus and the second cell is another cell than the serving cell of the apparatus.

21. The apparatus according to claim 18, wherein the at least one memory and the computer program code are configured to, with the at least one processor, further cause the apparatus to:
monitor the downlink control channel using said one or more control resource set parameter of a first cell when the TCI state indicates a reference signal associated with a cell identifier of the first cell; and
monitor the downlink control channel using said one or more control resource set parameter of a second cell when the TCI state indicates a reference signal associated with a cell identifier of the second cell.

22. The apparatus according to claim 18, wherein at least one of said one or more control resource set parameters to be used are conditionally activable depending on the cell identifier.

23. The apparatus according to claim 18, wherein said one or more parameters are search space specific.

24. The apparatus according to claim 23, wherein the search space is User Equipment specific Search Space or Common Search Space.

25. The apparatus according to claim 18, wherein the activation indication is a Medium Access Control Control Element, activation indication or a Downlink Control Information-based activation indication.

26. The apparatus according to claim 18, wherein the at least one memory and the computer program code are configured to, with the at least one processor, further cause the apparatus to:
determine that said one or more control resource set parameters are not configured for the control resource set when the control resource set is activated with the TCI state indicating a reference signal associated with a cell identifier of another cell than a serving cell of the apparatus; and
monitor, upon determining that said one or more control resource set parameters are not configured for the control resource set, the downlink control channel using one or more control resource set parameters based on a cell identifier associated with a reference signal indicated by the active TCI state for the control resource set.

27. The apparatus according to claim 18, wherein the at least one memory and the computer program code are configured to, with the at least one processor, further cause the apparatus to:
monitor the downlink control channel using said one or more control resource set parameters, wherein said one or more parameters are based on a cell identifier associated with a reference signal indicated by the active TCI state for the control resource set.

28. The apparatus according to claim 27, wherein the at least one memory and the computer program code are configured to, with the at least one processor, further cause the apparatus to:
perform said monitoring when the active TCI state indicates a reference signal associated with a cell different than a serving cell.

29. The apparatus according to claim 18, wherein the at least one memory and the computer program code are configured to, with the at least one processor, further cause the apparatus to:
monitor, upon determining that said one or more control resource set parameters are not configured for the control resource set, the downlink control channel using said one or more control resource set parameters of the cell identifier indicated by a reference signal associated with an active TCI state for the control resource set and for one or more search spaces configured for the control resource set.

30. The apparatus according to claim 18, wherein the at least one memory and the computer program code are configured to, with the at least one processor, further cause the apparatus to:
monitor the downlink control channel on the control resource set using said one or more control resource set parameters based on the cell identifier associated with a reference signal indicated by an active TCI state for the control resource set and for one or more search spaces configured for the control resource set.

31. The apparatus according to claim 18, wherein the cell identifier is a physical cell identifier or a re-indexed value of the physical cell identifier, and/or said one or more control resource set parameters comprise a Demodulation Reference Signal scrambling identity and/or precoder granularity.

32. The apparatus according to claim 18, wherein the at least one memory and the computer program code are configured to, with the at least one processor, further cause the apparatus to:
receive, from the wireless network node, a first control resource set configuration to be used when the TCI state indicates a reference signal associated with a cell identifier of a first cell and a second control resource set configuration to be used when the TCI state indicates a reference signal associated with a cell identifier of a second cell.

33. A method, comprising:
receiving from a wireless network node, by an apparatus, an activation indication activating a Transmission Configuration Indicator (TCI) state for a control resource set, wherein the TCI state indicates a reference signal associated with a cell identifier;
determining, by the apparatus, one or more control resource set parameters depending on the cell identifier; and
monitoring, by the apparatus, a downlink control channel using said one or more control resource set parameters.

34. The method according to claim 33, wherein at least one of said one or more control resource set parameters is specific for a first cell and at least one of said one or more control resource set parameters is specific for a second cell.

35. The method according to claim 33, further comprising:
monitoring the downlink control channel using said one or more control resource set parameter of a first cell when the TCI state indicates a reference signal associated with a cell identifier of the first cell; and
monitoring the downlink control channel using said one or more control resource set parameter of a second cell when the TCI state indicates a reference signal associated with a cell identifier of the second cell.

36. The method according to claim 33, wherein the first cell is a serving cell of the apparatus and the second cell is another cell than the serving cell of the apparatus.

37. The method according to claim 33, wherein at least one of said one or more control resource set parameters to be used are conditionally activable depending on the cell identifier.
